(19) United States
(12) Patent Application Publication
(10) Pub. No.: US 2017/0358238 A1
(43) Pub. Date: Dec. 14, 2017

(54) SPEED READING SYSTEM AND METHOD

(71) Applicant: Renato CASUTT, Chur (CH)

(72) Inventor: Renato CASUTT, Chur (CH)

(21) Appl. No.: 15/213,418

(22) Filed: Jul. 19, 2016

(30) Foreign Application Priority Data
Jun. 10, 2016 (EP) EP16001321.5

(51) Int. Cl. G09B 17/04; G06F 17/21; G09B 17/00; G06F 3/01; G06T 11/60

(52) U.S. Cl. CPC G09B 17/04; G09B 17/003; G06F 3/016; G06F 17/214; G06T 11/60

(57) ABSTRACT

A method for handling texts when reproduced on a display is provided. In a first step, a digitized text that is to be reproduced is selected. In a second step, a software program is executed, which includes at least one rule for the setting of at least one distinction that is perceptible when reproduced on the display and is incorporated into the digitized text. The software program is used on the digitized text in order, in accordance with the rule, to make the at least one distinction in the text.

### CROSS REFERENCE TO RELATED APPLIATIONS

This application claims priority to EU application no. EP16001321.5, filed 10 Jun. 2016, entitled SCHNELLLESEVERFAHREN UND-SYSTEM, the content of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance.

### COPYRIGHT AND LEGAL NOTICE

A part of the disclosure of this patent specification includes material that is protected by copyright. The copyright holder will not raise any objection to the reproduction of the patent specification or patent disclosure in its original form—regardless of by whom—, as it appears in the patent record and in the documents of the Patent and Trademark Office, but otherwise reserves all copyrights, in addition, none of the references to patents or products of third parties contained in this document is to be taken as an admission that the present invention is not entitled to predate such material based on a prior invention.

### BACKGROUND OF THE INVENTION

The invention relates to a method for improving the readability of digitized texts when they are reproduced on a variable display. The invention also relates to a software that is stored on a data carrier and is for carrying out the method.

The handling of large quantities of text—in commercial and public documents, emails, blogs, books, and prospectuses, to name only a few—has become an everyday problem. That which has been read is often quickly forgotten again or not even correctly registered in the first place. Due to the overloading of the eye, in many cases, the observer is no longer able to read a text in a correct and lasting way.

It is already known that this problem can be at least partially remedied by improving the readability of texts (original texts) through measures that relate to their reproduction. The invention lies generally in the area of such measures. In particular, the invention relates to the subjects defined in the independent claims.

### SUMMARY OF THE INVENTION

A method is provided for improving the readability of digitized texts when they are reproduced on a variable display. The invention is implemented by software that is stored on a data carrier. (see first paragraph of Background above for support)

Advantageous embodiments of the invention are defined in the claims which depend hereto.

### DESCRIPTION OF THE DRAWINGS

Preferred embodiments of the invention will be explained in greater detail below in conjunction with the accompanying drawings. In the drawings

FIG. 1 shows a flow chart for the analysis of the original text and its processing according to the invention;

FIG. 2A shows a flow chart for the selection of exemplary distinction rules;

FIG. 2B shows a set of seven exemplary rules;

FIG. 3-12 show sample texts resulting from application of the juxtaposed distinction rules (to the left thereof);

FIG. 13-15 show examples of various distinction types in which the left side describes the type of distinction and the right side displays an example of the text using the corresponding distinction type.

FIG. 16 is a schematic view of an alternate embodiment of the invention.

FIG. 17A is a side view of a portion of the tactile display of the alternate embodiment of the invention, in one state of operation.

FIG. 17B is a side view of a portion of the tactile display of the alternate embodiment of the invention, in another state of operation.

### DETAILED DESCRIPTION OF THE PREFERRED EMBODIMENT

The brain center that is responsible for reading assists the eye through selective simplification. For example when reading at the usual speed, no word is registered by the eye from the first letter to the last. The observer only absorbs the beginning letters of a word; the brain center then combines these with the ending letters of a word that the reader knows. Consequently, the eye and brain participate cooperatively in the reading process.

The original texts affected by this are usually homogeneously reproduced in conventional typography and do not contain any aids to improve the reading process. In printed texts, such aids had to already be provided during typesetting since a text can no longer be changed once it has been printed. The situation is different with digitized texts that are reproduced and read, for example, on a screen. In this case, a “subsequent” processing of the original text is possible that improves its readability and this constitutes an important focus of the invention.

When implementing the invention, the typeface of the original text is changed for the reproduction so that the eye is guided over the text by means of selectively produced fixation points 10. As a result, the content is read more quickly, consciously, and thus lastingly. The invention is therefore also referred to as “bionic typography,” as in the enclosed drawings.

The fixation points 10 are implemented according to the invention by means of distinctions (in the typographical sense), for example by reproducing letters that were in normal typeface in the original text (especially the beginning letters of words) in a holder typeface.

In the context of the present application, the term “distinction pattern” (or “pattern” for short) means the choice of text positions in which a distinction is set and thus a fixation point 10 is established. The choice of the distinction used in this case is referred to as the “distinction type.”

The visual perception occurs by means of fixations. During a fixation, the eye is directed at a fixation point 10 for about 0.3 seconds. It then jumps to another fixation point 10 in a quick, jerky movement (saccade). In the fixation phases, high-resolution detail visual images are captured via the fovea of the eye, but during saccades, no perception is possible. The sensation of seeing is maintained by means of the peripheral field of vision and the already stored visual impressions. The fixations serve to match internal mental images with reality. In this regard, perception differs from a computer input. An experienced person requires fewer fixations to recognize something than an inexperienced person. The number of fixations per second fluctuates only slightly and cannot be voluntarily influenced to any significant degree.

People read a text by allowing their eye to skip over the text along the reading direction to individual words or parts of words. During a fixation with a duration of 250 to 350 ms on average, partial perceptions are matched to stored data (visual word recognition).

If a word is unintelligible or unknown, frequently, the spelling-out method or sounding-out method are resorted to, which slows the reading process. If what has just been read makes no sense, regressions often occur (skipping back to passages of text that have already been read).

During reading, therefore, not every individual word is fixated upon. By contrast, depending on the existing visual vocabulary, long and unusual words require several fixations for a correct word recognition.

In preferred embodiments of the invention, the fixation points 10 (implemented in the form of distinctions) are set to selectable smaller or larger distances. For example, fixation points 10 are defined after every second, third, fourth, etc. word and the thus-defined distinction pattern 50 is applied to the entire text by means of an algorithm. In other embodiments, the first word of each sentence or of every other sentence is marked by distinction. The setting of fixation points 10 can follow a programmed preset pattern that the reader simply selects. Alternatively, it is possible for the reader to define his own pattern and to save it in the program. It is thus possible for each reader to select his individually preferred pattern of distinctions (fixation points 10 in accordance with his reading behavior and to have it displayed visually by the software. This makes it possible to adapt the distinction pattern 50 to the reading habits and experience of the reader, the difficulty of the text, and other individual aspects of the interaction between the reader and reading material.

Whereas in the embodiment of the invention described above, the fixation points 10 are set in accordance with an established repetition frequency, in other embodiments, special criteria must be taken into account when setting the fixation points 10. It is thus possible to provide distinctions to especially longer words, foreign words, technical terms, or for example words beginning with capital letters. For such purposes, the software will contain a corresponding rule and may include a library function.

An example for the application of such special distinction rules is based on a word recognition for which the text is processed by means of a corresponding word recognition component of the software. For example, this word recognition component determines in the text those components (e.g. words) that exhibit a high repetition rate. This can relate to the entire text or to individual segments of text. Such particularly frequently occurring components are then not distinguished since they are not suitable for use as fixation points 10. The components that exhibit a low repetition rate are provided with a distinction according to the invention, for example in that the two first letters are reproduced in a bolder typeface than the subsequent letters. The repetition rate in question here can be defined in any way, for example based on the mean (average) repetition rate in comparison to all of the components occurring in the text, or based on a numerically defined number of repetitions in the text. For example, distinctions can be provided only to those components that occur only once or at most three times in the text. The distinction rule can, for example, take into account whether components begin with capital letters.

If one wishes to apply such a rule to the case described above, in which a fixed repetition frequency of the distinction is defined, then the components whose repetition frequency in the text is “high” are not taken into account in the application of the fixed repetition frequency. Then for example every other component is emphasized by distinction, but the components that occur with a “high” repetition frequency are not counted. As a result, every other component is then not emphasized by distinction on the display.

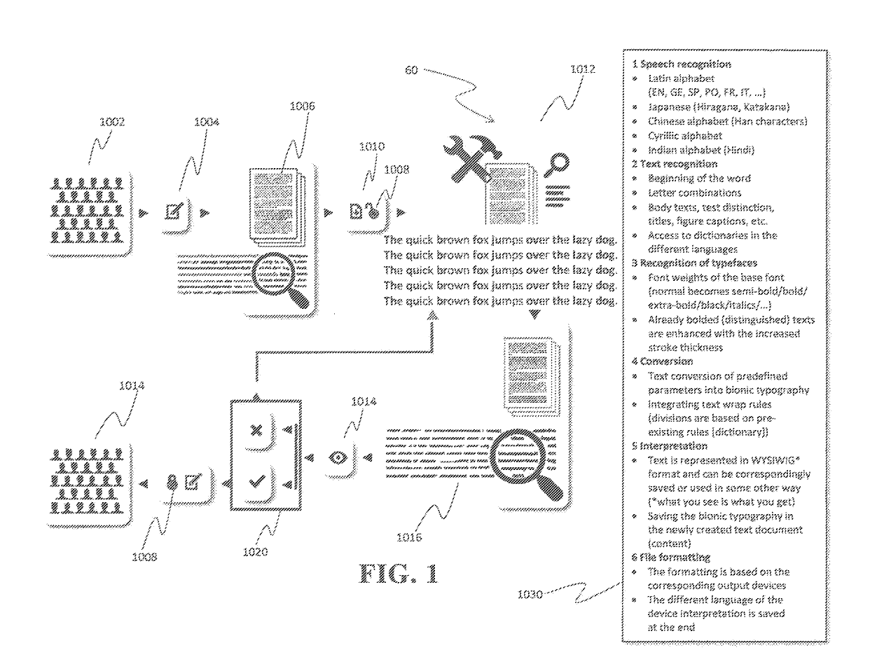

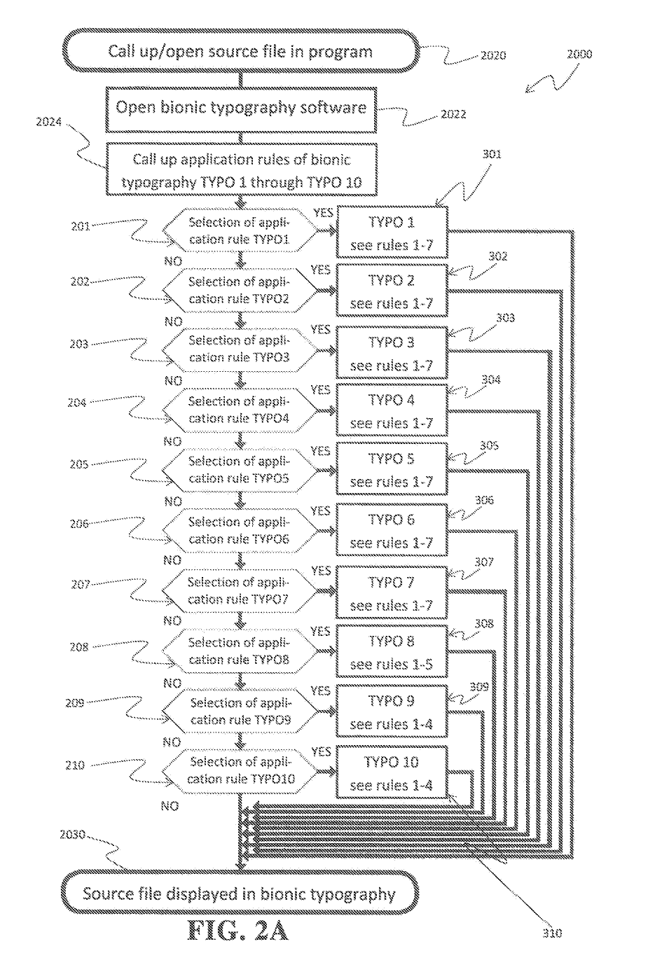

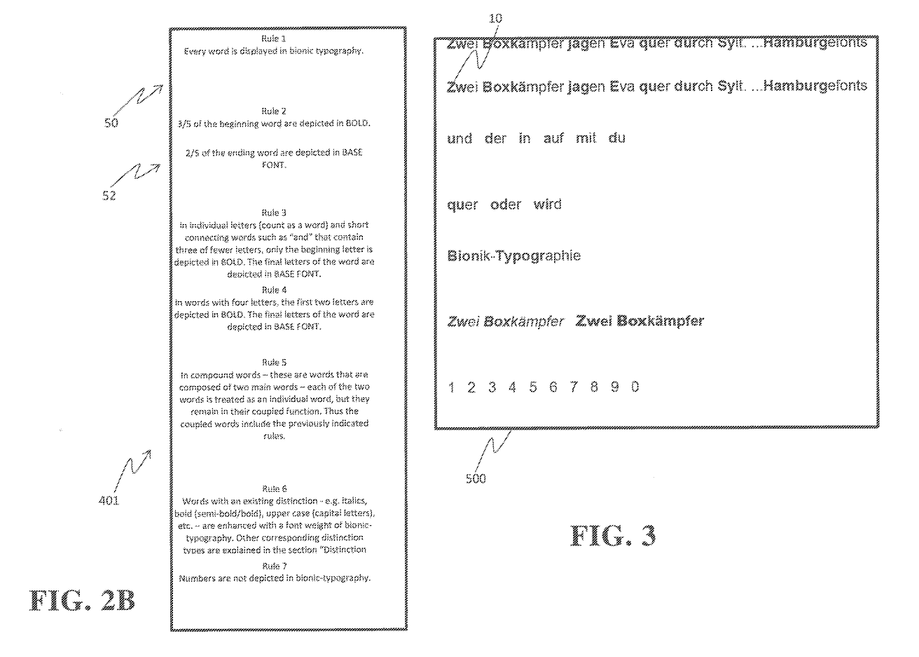

Referring now to FIGS. 1 and 2A, the software used according to the invention is based on rules 301, 302, 303, 304, 305, 306, 307, 308, 309, 310, 401, 402, 403, 404, 405, 406, 407, 408, 409, 410 stored therein that permit the depiction of the text to be adapted to the reading speed of the user. This is based on the selected increase in optical recognizability of text components in the body text that has been converted according to the invention. The user can select 201, 202, 203, 204, 205, 206, 207, 208, 209, 210 a suitable rule 301, 302, 303, 304, 305, 306, 307, 308, 309, 310, 401, 402, 403, 404, 405, 406, 407, 408, 409, 410 from the rules preset by the system or can himself define a rule that is conducive to his optimum reading speed or his optimum text comprehension. The choice of the rule produces the conversion of the original text according to the selected pattern of fixation points 10 (that corresponds to the rule), for example the emphasis of certain word fragments through corresponding distinctions at certain text positions, with the remaining word fragments then being depicted in a less conspicuous and thus less visible fashion.

The user can download a corresponding software onto his digital medium (PC, laptop, tablet, e-reader, smartphone etc.), in particular from a corresponding provider on the Internet. After installation, the software can be used on any digital text to embody its reproduction on the display of the medium in accordance with a selected or user-defined distinction rule.

The fixation points 10 are based on the optical parameters of (typographical) distinction types. The distinction types can be combined with one another. It is thus possible, for example, to combine the distinction “extra bold” with the distinction “bold,” for example by depicting the starting letter of a word in extra bold and the following letter in bold. It is likewise possible to also assign a distinction to the final letters in order to thus intensify the starting letters.

The invention is suitable for all of the font weights within font families and font superfamilies (hybrid fonts). The font standardization with font width (compressed, condensed, normal, extended, . . . ), font style (normal, italic), and stroke width (fine, narrow, normal, medium, bold, extra bold, ultra bold, . . . ) of the individual font is central to a font family. All fonts are defined by the font standardization and are thus assigned their independent depiction type (e.g. normal, bold, italic, . . . ). A font superfamily is the largest form of a collection of various font weights within the same font. Thus various features of a font can be combined within a font superfamily. If a font is designed without serifs, then within the font superfamily, there can also be a font family that includes a font without serifs [sic—with serifs]. The structure of this is as follows: 1. font superfamily (includes a plurality of font families of different types {with serifs, without serifs}), 2. font family (includes a plurality of fonts of the same type), 3. font (i.e. the font with the corresponding font weight).

The invention can be used outside of font families; e.g. In font mixes, distinction types, and other atypical font combinations. For the distinction type 52 of individual letter combinations with the use of the invention, the following variants are particularly preferable: “bold” . . . within the stroke width “extra bold” . . . , “italics,” “condensed,” “expanded,” “font size,” “negative,” “different font,” “underline,” and “all caps.” In preferred embodiments, the reader can select both the distinction pattern 50 and the distinction type 52 from among a plurality of presets or can even define them as a rule himself.

In this connection, a text in the sense of the invention is in particular, but not exclusively, a “. . . thematic and/or functionally oriented, coherent linguistic or linguistic/figurative complex that has been produced with a particular [. . .] communication aim [. . . ], fulfills a recognizable communicative function [. . .], and constitutes a closed unit in terms of its content and function.” (Susanne Göpferich: Text Types in Natural Sciences and Technology. Pragmatic Typology—A Contrast [Textsorten in Naturwissenschaften and Technik. Pragmatische Typologic—Kontrastierung] —Translation. Forum for Foreign Language Research 27 [Forum für Fremdsprachen-Forschting 27], Narr, Tübingen 1995). A text is thus in particular a sequence of words that in the syntactical context, constitute a substantial statement. Texts in the sense of the invention can include numbers, symbols, and the like. A table in the sense of the invention constitutes a text, even if it does not contain words. The software-determined rule for setting the fixation points 10 can be defined so that it only takes into account words (but no numbers, symbols, etc.). Alternatively, the rule can distinguish, for example, all (or individual) elements of a text that are not words.

The invention can be used independent of the language in which the text is written, in particularly preferred embodiments, the text involves languages that can be represented by alphabetical characters. It is also possible, however, for syllabic writing systems and other symbolic systems to be handled according to the invention.

According to the invention, the source of an original text is not important. What is relevant is that it is in a digitized form so that the invention can be used on the text in order to produce the fixation points 10 and to legibly reproduce the text that has been changed in this way. The original text can be digital, for example like a text written on a PC, in an email, or the like. In lieu of this, the text can originally be in the form of a hardcopy text, for example a page of a book, a typescript, or even hand-written notes. In such cases, the digitization of the text as a rule precedes the processing according to the invention.

The changed text is reproduced by means of a display. A display in the sense of the invention is any device with which a set of digital data that correspond to the text can be reproduced so that it can be read by a person. Preferably, the display is a monitor or screen, for example that of a PC or tablet. The reproduction of the text that has been changed according to the invention is then visually perceptible. For example, however, the invention can also be used with tactilely readable text (for example texts in Braille, by means of a Braille display).

The technical implementation of the invention is carried out by means of suitable software-based devices. In this connection, these can be devices especially designed for implementing the invention. It is also possible, however, to implement the invention using existing devices that already have the necessary functional devices (modules) for other purposes. Possible instances of these include in particular known mobile phones (provided that they have a suitable display), tablets, PCs, e-readers, and the like. It is possible for the software that is required for the implementation of the invention to be embodied in the form of an “app” that the user downloads onto his device, for example via the Internet. The text that is distinguished according to the invention is then shown on the display of this device.

In preferred embodiments, such a device is equipped with an input module for recording data that correspond to a digitized text; a memory module for a processing program, which includes at least one rule for the setting of at least one distinction in a digitized text; a processing module that uses the at least one rule on the data in the input module in order to provide the digitized text with the at least one distinction; and a display module 170 for showing the distinguished text on a display. Such modules are already contained in known devices such as the mobile phones, etc, mentioned above.

If the user is to be able to select from among different distinction patterns 50 and/or distinction types 52, then the device will include an input module 155 for defining and/or selecting a rule for the setting of distinctions. The devices mentioned above include input modules 155 that can be used for this function.

The implementation of the software that is required according to the invention can be oriented on publications that address the processing of texts. Examples of these include U.S. Pat. No. 6,820,237 (Suhayya et al.), U.S. Pat. No. 7,702,611 (Chi et al.), and US 2002/124026 (Weber), all of which—by virtue of being mentioned—are hereby incorporated into the disclosure content of the present application and are referred to in order to disclose functional aspects of the present invention.

Referring again in particular to FIG. 1, a schematic flow diagram 1000 of the workflow of the invention. The diagram 1000 shows the (software-executable) steps by which an original text is initially analyzed. Of course, authors 1002 must first prepare, via a writing step 1004, a basic electronic text 1006. This electronic text 1006 is unlocked via an unlock function 1008 and processed by software 1010 to yield a processed text 1012. Alternatively, a user having difficulty reading (visually, here represented with an eye symbol 1014 certain text 1016 may select via a drop down menu (not shown) or decision tree 1020 according to a selected rule or set of rules (see FIG. 2). The text 1016 is then unlocked via the unlock function 1008 and processed as above using the rule or rules selected to yield a processed text 1012, which may be made available to many readers 1014. The workflow may include speech recognition, text recognition, and typeface recognition steps.

Referring to schematic block 1030, speech recognition may be used to capture the electronic text. Text recognition may be used to convert printed text into electronic text. Typeface recognition may be used to select compatible typeface elements with the legacy typeface elements. Speech recognition typically uses the Latin alphabet composed in any number of languages, such as EN, GE, SP, PO, FR, IT . . . Japanese (Hiragana, Katakana), Chinese alphabet (Han characters), Cyrillic alphabet, or Hindi alphabet (Hindi). Text recognition functionality identifies the beginning of a word, or letter combinations, body text, text distinction, titles, figure captions, etc. Access to definitions in different languages is useful. Recognition of typefaces functionality recognizes font weight of the basic font (normal becomes semi-bolded or extra bold and black is underlined or block-reversed). Already bolded (distinguished) texts are enhanced with an increased stroke thickness. The processing using the bionic typography of the invention results in text converted according to predetermined parameters. Integrating text wrap rules (in which divisions are based on pre-existing rules, where a dictionary check may sometimes be required. In interpreting the processed text which is presented in WYSIWYG format, the text can be saved or used in some other way. Of course, the processed text may be saved in a newly created text document (content). In file formatting, this is based on the corresponding output devices. The different language of the device interpretation is finally saved.

Then comes the text processing 60 (conversion) according to the invention in which distinction pattern 50 and distinction type 52 are applied to the analyzed original text. The resulting changed text can be saved and/or output (interpretation) and can be saved as a file (file formatting).

Referring now to FIG. 2A, a flow chart 2000 for the selection of rules 2002 is shown. Each rule is designated TYPO1 to TYPO10, but of course many more rules can be selected. Note that the rule name “TYPO” has nothing to do with the common meaning of a “typo” in the English language, The decision blocks 201, 202, 203, 204, 205, 206, 207, 208, 209, 210 are therein illustrated from among a total of 10 rules 301, 302, 303, 304, 305, 306, 307, 308, 309, 310, 401, 402, 403, 404, 405, 406, 407, 408, 409, 410 that correspond to particular distinction patterns and distinction types. In a first step 2020, the source text file is called up for processing. In a second step 2022, the bionic typography module of the invention is called up in a third step 2024, the rules 301, 302, 303, 304, 305, 306, 307, 308, 309, 310, 401, 402, 403, 404, 405, 406, 407, 408, 409, 410 are called up and a selection is made among them typically using a yes-no decision block 201, 202, 203, 204, 205, 206, 207, 208, 209, 210. In a fourth step 2026, the selected rules are applied to the source text. In a fifth step 2030, the source file is displayed in bionic typographical format.

FIG. 3 shows the sample text 500 corresponding to the rules of FIG. 2A.

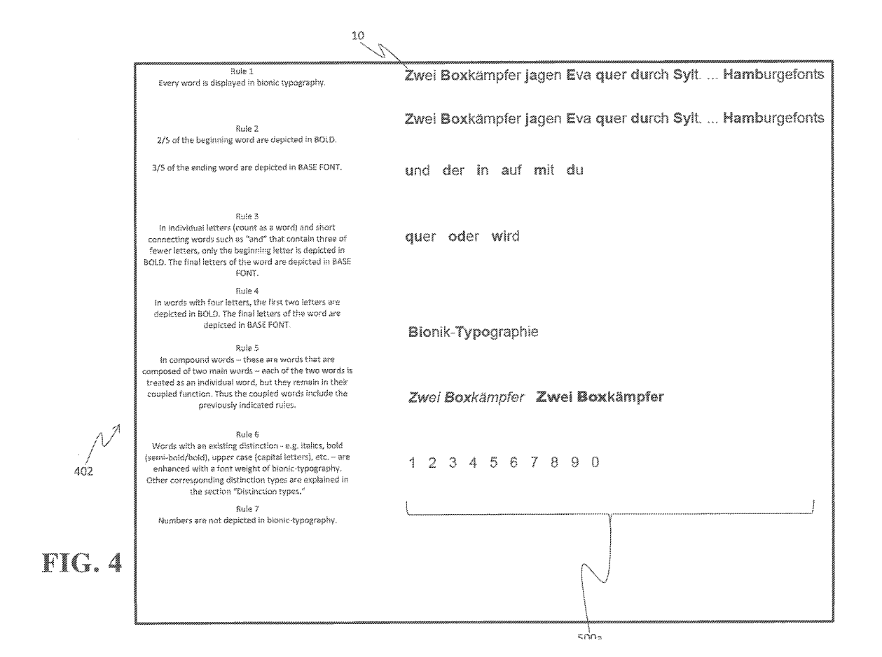

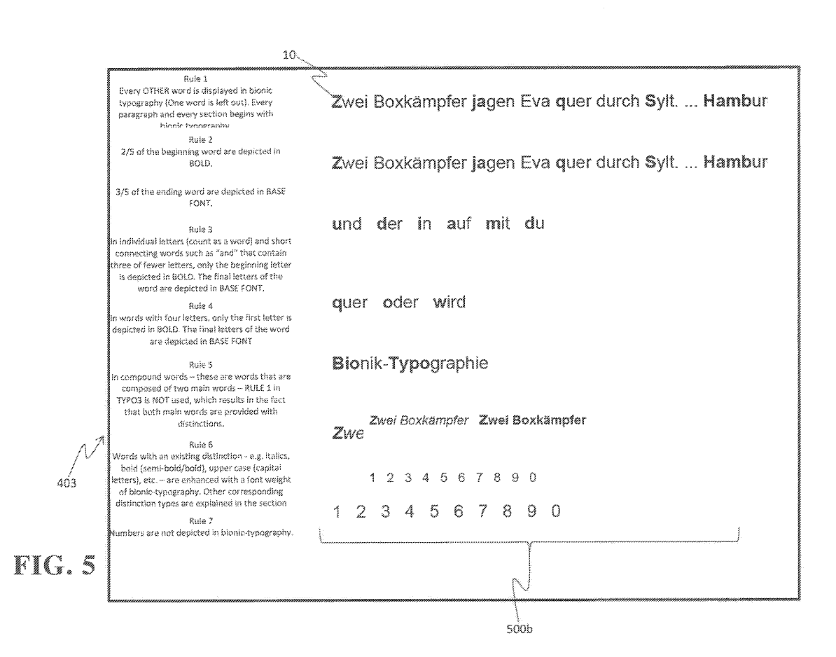

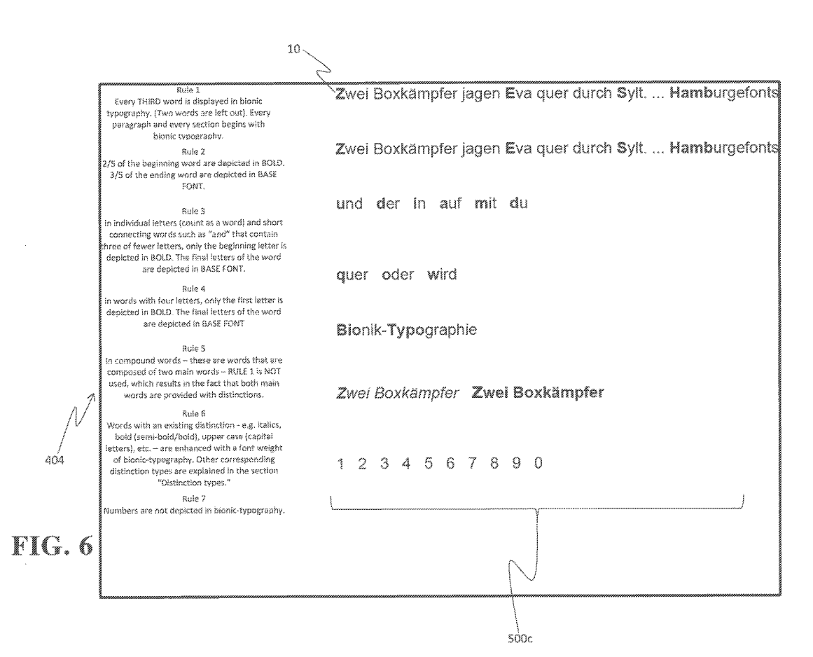

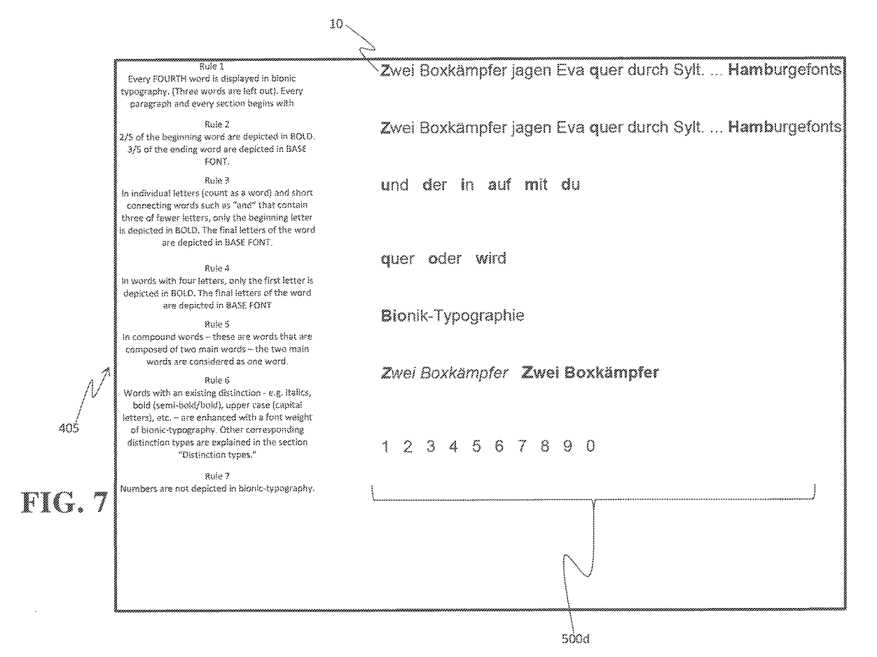

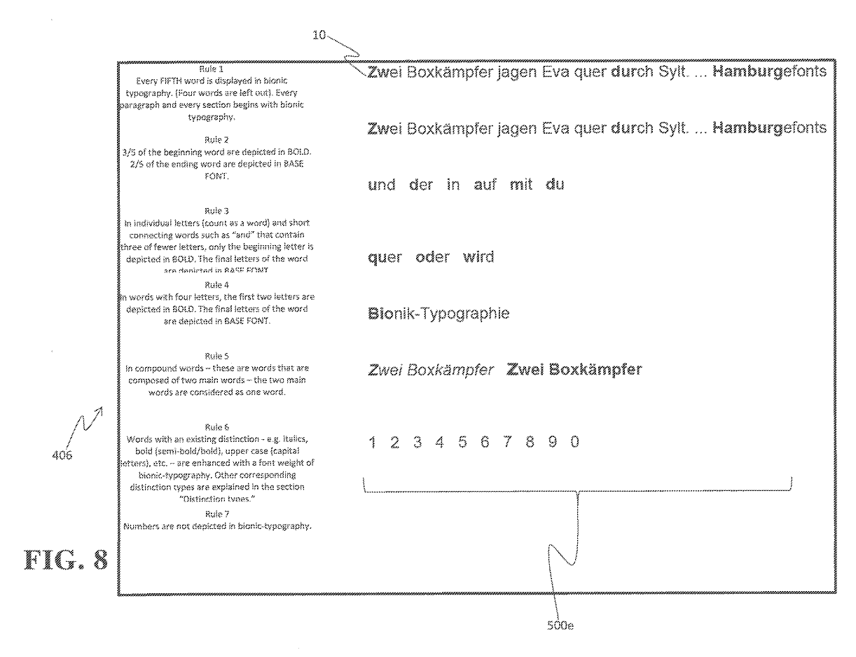

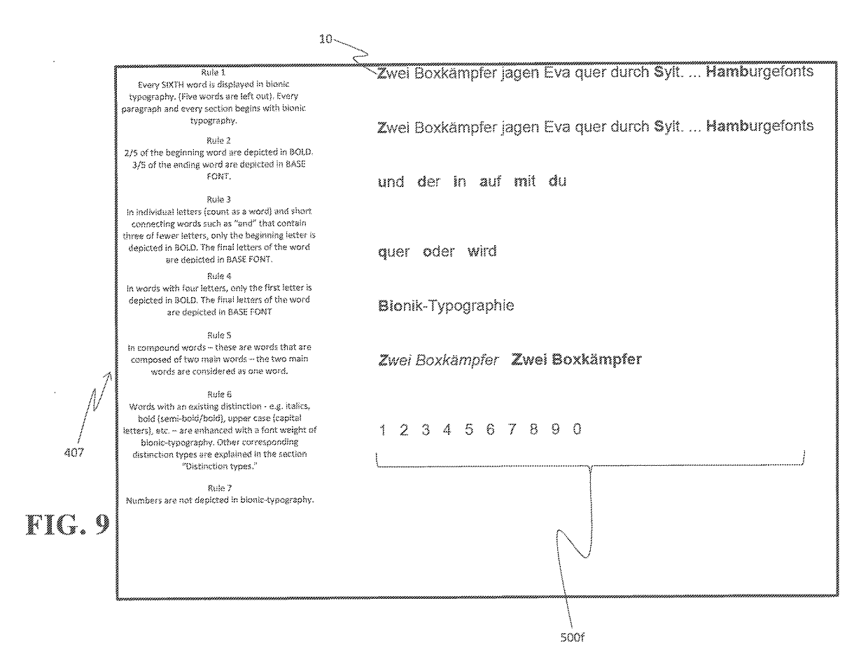

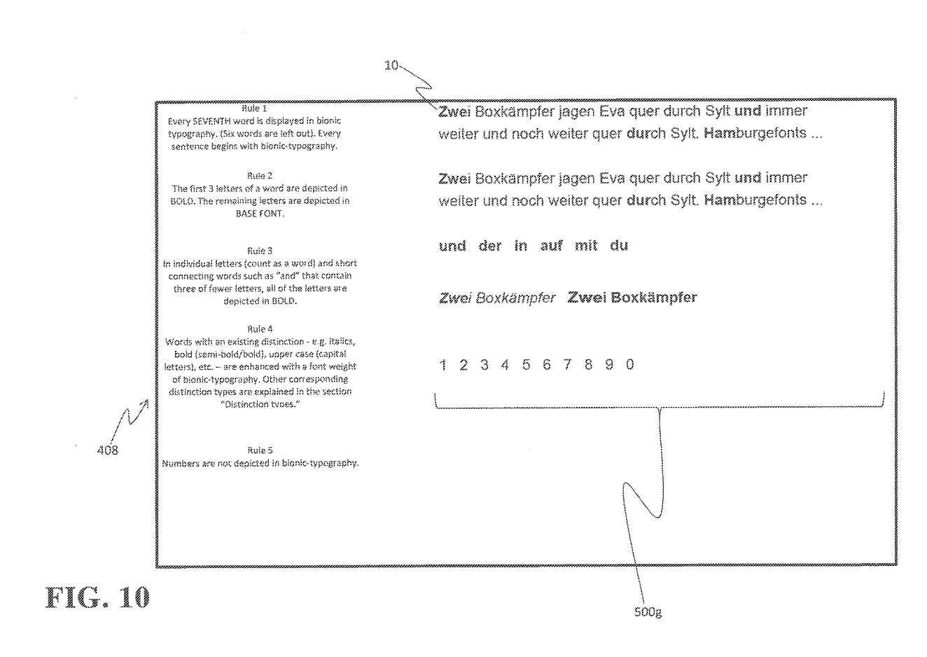

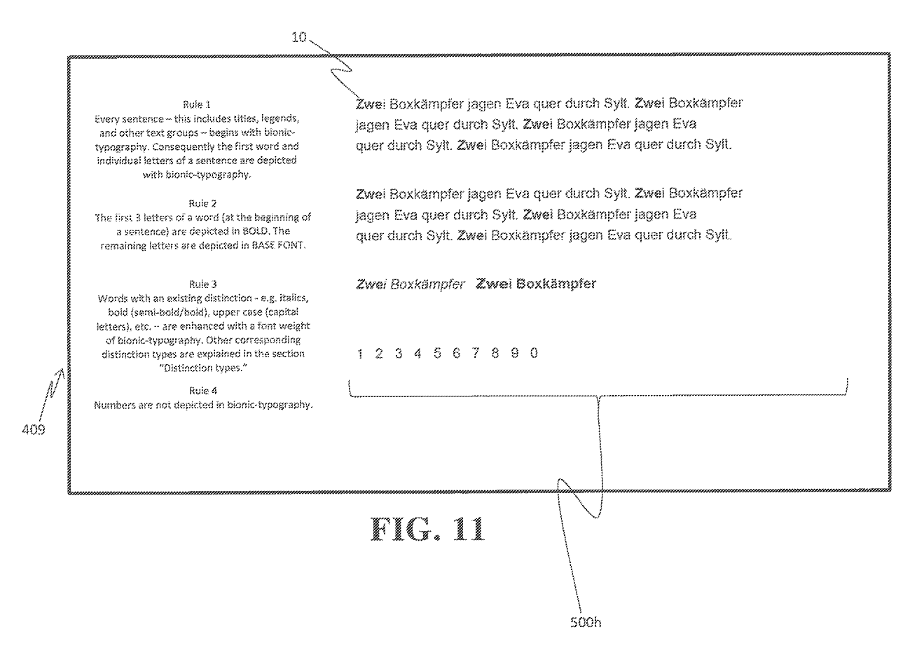

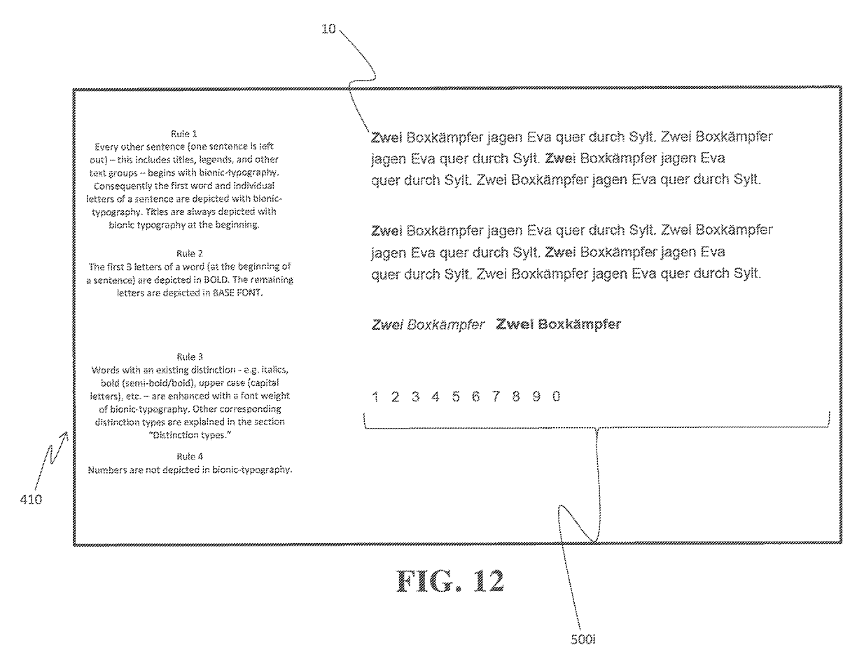

FIG. 4-12 show sample texts 500a, 500b, 500c, 500d, 500e, 500f, 500g, 500h, 500i resulting from application of the juxtaposed distinction rules (to the left thereof);

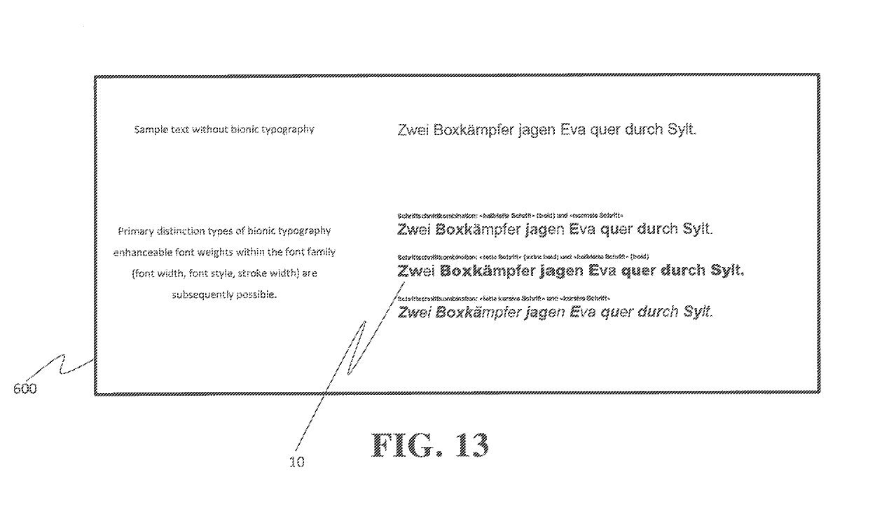

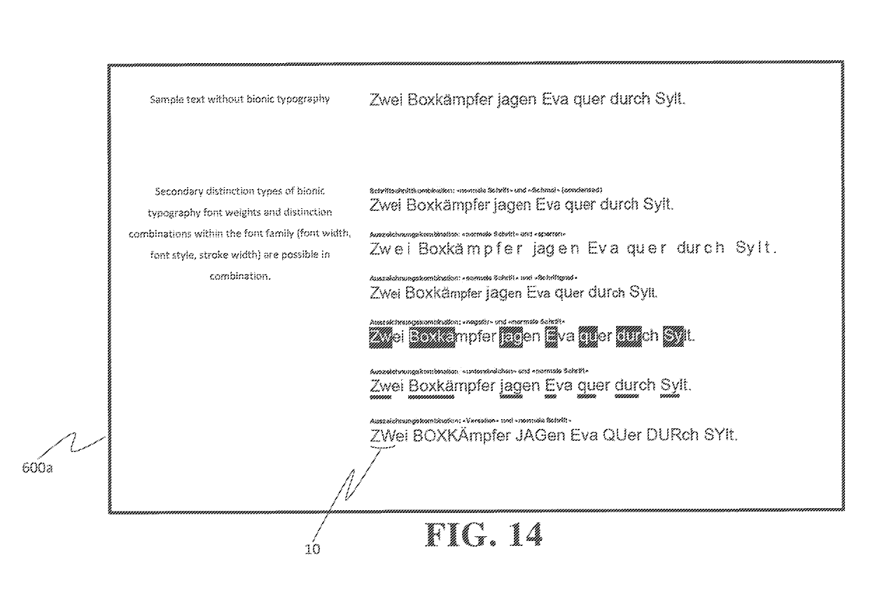

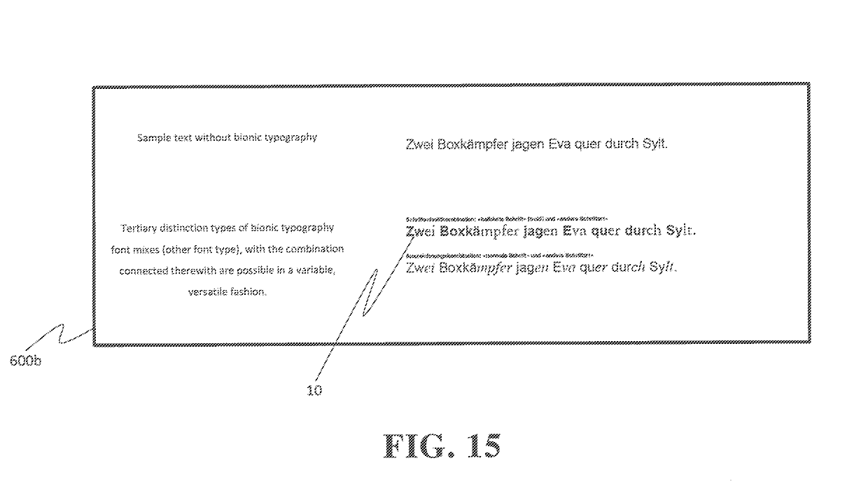

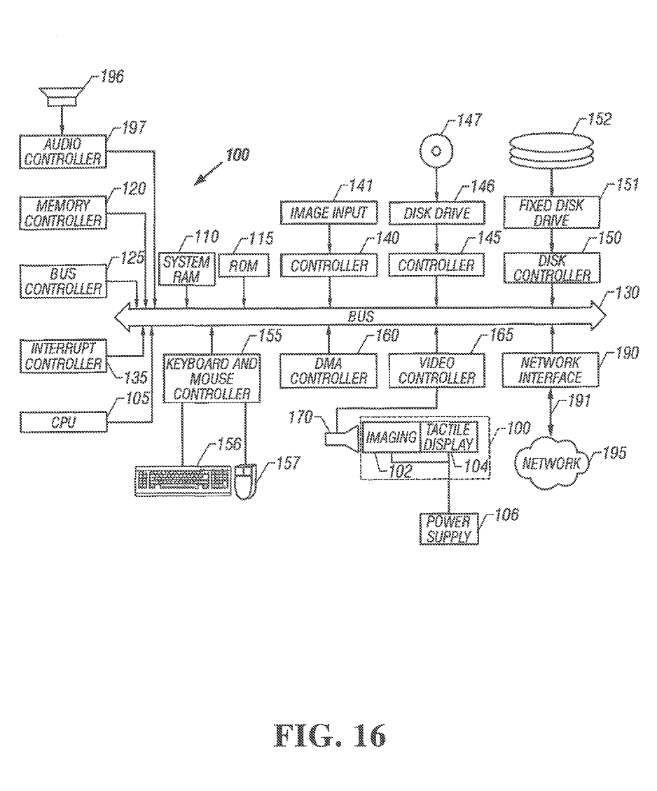

FIGS. 13-15 show examples 600, 600a, 600b of various distinction types at fixation points 10 in which the left side describes the type of distinction and the right side displays an example of the text using the corresponding distinction type.

The application fields of the invention are innumerable; a selection of preferred application fields is listed below as “Application fields,”

The reproduction of a text that has been changed according to the invention is then visually perceptible. The invention can, however, also be used for example with tactilely readable texts (for example texts in Braille by means of a Braille display). The disclosure of U.S. Pat. No. 6,636,202, for Ishmael Jr., the application for which was filed on Apr. 27, 2001, is included herein by reference and is referred to in order to describe essential aspects of the tactile display and the conversion of incident light from a visual image into electrical signals, which are proportional to the grayscale intensity of the incident light, which puts the method and device of the present invention in a position to produce a distinction by raising elements of the tactile display as described in the patent by Ishmael Jr.

### Application Fields

Application fields of digital media

Prerequisite: preinstalled online applications

email (Apple, Microsoft, IBM, Dell)

e-book (Kindle, Kobo, Tolino)

social media (Facebook, Twitter)

blogs (Tumblr, freelance journalism)

service portals

search engines (Google, Yahoo, Bing, DuckDuckGo)

smartphones/tablets for communications applications (Samsung, Apple, HTC, Blackberry)

websites (company content)

e-papers (media landscape)

other

Application fields of analog media

Prerequisite: preinstalled DTP programs from publishers such as Adobe (InDesign, Acrobat, Illustrator, . . . ), Microsoft (Word, Excel, . . . ), Apple (Pages, TextEdit, . . . )

desktop publishing (Adobe, Microsoft Dos, Apple)

universities

schools

countries/territories (respective agencies)

other

Products of analog media

hooks

periodicals (media landscape)

users manuals

operating instructions

general terms and conditions

business reports

newspapers/magazines

prospectuses

brochures

other

In one embodiment, the apparatus comprises imaging means for converting incident light from a visual image into electronic signals that are proportional to the gray scale intensity of the incident light. The height of each pixel in the tactile display is dynamically variable in proportion to the electrical signals from the imaging means. (see col. 1, lines 59-67 of '202 patent).

Referring now to FIG. 16, an exemplary system architecture for a computer system 100 is shown.

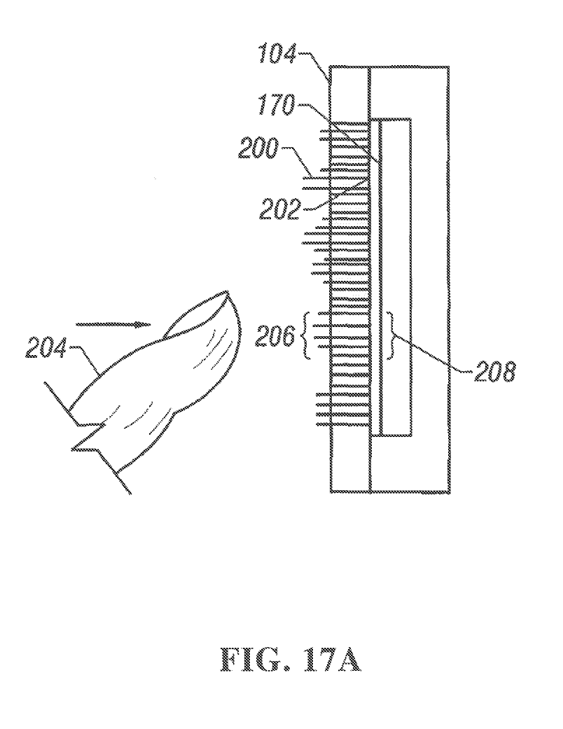

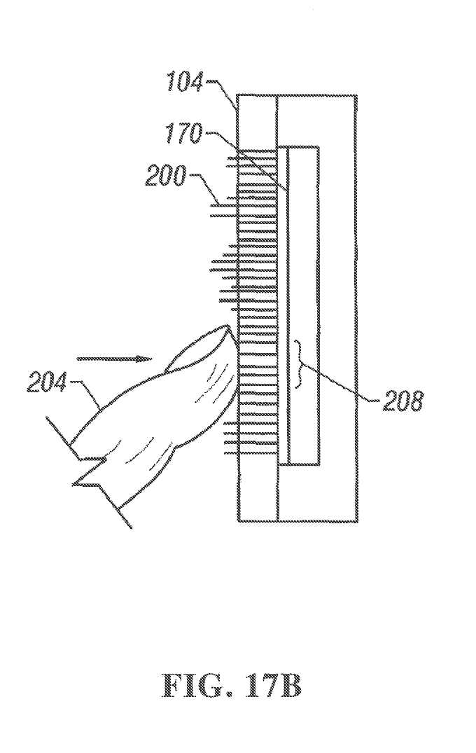

FIG. 16 illustrates an exemplary system architecture for a computer system 100, such as the personal computer system, on which the invention may be implemented. The exemplary computer system of FIG. 16 is for descriptive purposes only. Although the description may refer to terms commonly used in describing particular computer systems, the description and concepts equally apply to other systems, including systems having dissimilar architectures. Computer system 100 includes a central processing unit (CPU) 105, which may be implemented with a conventional microprocessor, a random access memory (RAM) 110 for temporary storage of information, and a read only memory (ROM) 115 for permanent storage of information. A memory controller 120 is provided for controlling RAM 110. A bus 130 interconnects the components of computer system 100. A bus controller 125 is provided for controlling bus 130. An interrupt controller 135 is used for receiving and processing various interrupt signals from the system components. Mass storage of data may be provided by a diskette, CD ROM 147, or hard drive 152. Data and software may be exchanged with computer system 100 via removable media 147 such as diskette of CD ROM. Removable media 147 is insertable into drive 146 that is, in turn, connected to bus 130 by a controller 145. Hard disk 152 is part of a fixed disk drive 151 that is connected to bus 130 by controller 150. User input to computer system 100 may be provided by a number of devices. For example, a keyboard 156 and mouse 157 are connected to bus 130 by controller 155. Similarly, an image input device 141, such as a scanner, is connected to bus 130 by controller 140. An optional audio transducer 196, which may act as both a microphone and a speaker, is connected to bus 130 by audio controller 197, as illustrated. It will be obvious to those skilled in the art that other input devices, such as a pen and/or tabloid may be connected to bus 130 and an appropriate controller and software, as required. Direct memory access (DMA) controller 160 is provided for performing direct memory access to RAM 110. A visual display is generated by video controller 165 that controls video display 170. Computer system 100 also includes a communications adaptor 190 that allows the system to be interconnected to a local area network (LAN) or a wide area network (WAN), schematically illustrated by bus 191 and network 195. Operation of computer system 100 is generally controlled and coordinated by operating system software, such as the OS/2® operating system, available from international Business Machines Corporation, Boca Raton, Fla. or Windows 95® from Microsoft Corp., Edmond, Wash. The operating system controls allocation of system resources and performs tasks such as processing scheduling, memory management, networking, and I/O services, among things. In particular, an operating system resident in system memory and running on CPU 105 coordinates the operation of the other elements of computer system 100. The present invention may be implemented with any number of commercially available operating systems including OS/2, UNIX Windows NT and DOS, etc, One or more applications, such as Lotus Notes, commercially available from Lotus Development Corp., Cambridge, Mass., may be executable under the direction of the operating system. If the operating system is a true multitasking operating system, such as OS/2, multiple applications may execute simultaneously. (see col. 4, line 22 to col. 5, line 19 of '202 patent). As shown in FIGS. 17A and 17B, the tactile display 104 may be secured at a narrow gap from the surface of the touch screen 170 so that touching or pressing the individual pins 200 in the tactile display conveys or transmits a similar touching or pressing upon the touch screen 170. By positioning the imaging means or photometer in or near the end 202 of the pins 200, the imaging/tactile device forms a true and complete interface, i.e., both input and output, between the touch screen 170 of the computing device and the operator's finger 204. The interaction between the tactile display and the touch screen display relies upon the user's touch input and does not require any direct electronic attachments or communications with the computing device. FIG. 17B illustrates that pressing the finger 204 against the pins 200 in a region 206 of the tactile display 104 will cause the pins to touch the touch screen 170 in a region 208 that is directly behind the region 206. The tactile display means may comprise a plurality of individually controlled miniature actuators, a plurality of miniature gear assemblies, and a plurality of rods. The miniature actuators, e.g., motors, piezoelectric materials, shape memory elements or solenoids, are oriented in a grid, wherein each of the motors or solenoids responds to a portion of the processed electrical signals. Apparatus using shape memory elements to for a tactile display are described in U.S. Pat. No. 5,244,288, which patent is incorporated by reference herein, (see col. 5, line 44 to col. 6, line 3 of '202 patent)

The apparatus 100 of the present invention has an imaging device 102 aligned with the video display 170. The tactile display device 104 receives information in the form of light from the imaging device 102 and provides a tactile image in accordance with the information. In this embodiment, the apparatus 100 is shown coupled to an external power supply 106, such as an electrical outlet. (see col. 5, lines 20 to 27 of '202 patent)

According to the invention, imaging means converts light received from the displayed visual image into electrical signals. An array of photometers of various types, such as photodiodes, may be used to form the imaging means. The tactile display means converts the electrical signals from the photometers into “tactile images” corresponding to the displayed visual image. Consequently, the tactile images can be perceived through the sense of touch by a person, such as a visually impaired person. Therefore, the tactile images are felt by the visually impaired person and enable them to interact with computers in a manner similar to how a sighted person would interact with graphical user interface. While the tactile display means is preferably of the same length and width dimensions as the image being processed, it is possible for the tactile display means to be scaled to a smaller or bigger size. (see col. 5, lines 28 to 43 of '202 patent)

The interaction between the tactile display and the touch screen display relies upon the user's touch input and does riot require any direct electronic attachments or communications with the computing device. (see col. 5, lines 53 to 56 of '202 patent)

The tactile display means may comprise a plurality of individually controlled miniature actuators, a plurality of miniature gear assemblies, and a plurality of rods. The miniature actuators, e.g., motors, piezoelectric materials, shape memory elements or solenoids, are oriented in a grid, wherein each of the motors or solenoids responds to a portion of the processed electrical signals. (see col. 5, lines 61 to 67 of '202 patent)

As can be seen, the invention may utilize several tactile display means, including mechanical means, electrochemical means, electromagnetic means, and fluid pressure means. For example, a suitable mechanical means includes rods, racks and gears. Suitable electrochemical means includes use of a polar organic gel in combination with electrodes. Exemplary electromagnetic means include an electromagnet causing a pin to move upwardly. Fluid pressure means may include either air or hydraulic fluid moving a pin upwardly. These examples are not meant to limit the present invention in any way. Any tactile display means would be acceptable. (see col. 7, lines 38 to 49 of '202 patent)

In accordance with the present invention, the height of the pixels in the tactile display is variable in proportion to the gray scale intensity of light incident on the imaging means from a visual display screen. The term “gray scale intensity” refers to the magnitude of light per unit area without regard to the actual color. However, as with the gray scale images on black and white televisions, colors are represented as various shades of gray along with white and black. (see col. 7, line 64 to col. 8, line 4 of '202 patent)

Because the apparatus of the invention senses the gray scale intensity of images, the apparatus is compatible with a wide variety of displays, whether they emit light or merely reflect light. This ability allows the apparatus to work universally with color, monochrome, and LCD displays without customization of the apparatus. Also, because the apparatus senses the light incident from a visual display, there is no need for the apparatus to be in electronic communication with the device generating the visual display. (see col. 8, lines 11 to 19 of '202 patent)

When light is sensed that indicates that a letter is presented in bold (as shown in the FIGS. 3 to 12), then the actuators react in an appropriate manner to distinguish the bold letters from the lowercase letters, giving a blind person a hint of the meaning of the words through feeling the raised bolded letters that provide more information on the meaning of the word which is in part bolded.

In more detail in one embodiment, there is provided a plurality of individually controlled miniature motors oriented in a grid, each of which responds to a portion of the processed electrical signals. A plurality of miniature rack and pinion gear assemblies are also provided, each of which is operatively connected to one of the miniature motors so that rotational motion of a pinion connected to a shaft of a miniature motor is converted into linear motion of a rack. A plurality of rods form the surface of the tactile display, each of which is connected to one of the racks, so that when the racks move linearly, the rods move linearly as well. The relative linear motion of the individual rods forms a “tactile image.” The motors could be formed by micro or nano-motors to produce very high resolution tactile images. (see col. 8, lines 47 to 60 of '202 patent)

1. A method for handling texts when they are reproduced on a display, in which
a digitized text that is to be processed is selected;
a software program is loaded, which includes at least one rule for the setting of at least one distinction that is perceptible when reproduced on the display, such distinction being incorporated into the digitized text; and
the software program is executed so as to process the digitized text in order, to male the at least one distinction in the text in accordance with the rule, the distinction improving the perceptibility of the text.

2. The method according to claim 1, in which the software program includes a plurality of different rules that can be selected.

3. The method according to claim 1, in which the distinctions are visually or tactilely perceptible.

4. The method according to claim 1, in which the display is a screen.

5. The method according to claim 1, in which the software program includes a plurality of different rules that correspond to the different distinctions and that can be selected by the user of the method.

6. The method according to claim 1, in which the distinctions correspond to the emphasis of individual text components.

7. The method according to claim 6, in which the emphasis is carried out in a bold typeface.

8. The method according to claim 6, in which the emphasis is carried out by means of a raising of letters in a tactile display.

9. The method according to claim 1, in which the text includes words and the distinctions in the reproduction of individual letters or sequences of letters are composed of a typographically different form.

10. The method according to claim 1, in which active distinctions are used, in particular extra bold or bold letters.

11. The method according to claim 1, in which distinctions are added to the beginnings of words, in particular the beginning letters.

12. The method according to claim 1, in which the at least one rule includes the repetition frequency with which the distinction is set.

13. The method according to claim 12, in which the repetition frequency is based on the number of non-distinguished text components between two distinguished text components.

14. The method according to claim 12, in which the repetition frequency is based on the number of non-distinguished sets of text components between two distinguished sets of text components.

15. The method according to claim 1, in which the text includes at least one sentence that includes a plurality of words, in which at least two words are distinguished.

16. The method according to claim 1, in which the text includes a plurality of sentences that include a plurality of words, and in which at least two sentences are distinguished.

17. A device for carrying out the method according to claim 1, having an input module for recording data that correspond to a digitized text; a speech module for a processing program that includes at least one rule for the setting of at least one distinction in a digitized text; a processing module that uses the at least one rule on the data in the input module in order to provide the digitized text with the at least one distinction, and a display module in order to show the distinguished text on a display, and a software program according to claim 16 implemented in the device.

18. The device according to claim 17, which is implemented as part of a mobile phone, a tablet, a PC, or a digital reading device.

19. The device according to claim 17, which includes an input module for defining and/or selecting a rule for the setting of distinctions.

20. The device according to claim 17, in which the user, in particular the author or reader of a text, can select or define a software rule, which corresponds to the particular meaning of text passages and in response thereto, the device provides the text with distinctions in accordance with the rule, which distinctions essentially permit a speed-reader to skip or jump over less important portions of text.
